(19) United States
(12) Patent Application Publication
(10) Pub. No.: US 2026/0257364 A1
(43) Pub. Date: Sep. 3, 2026

(54) Checking a Safety Configuration of a Robot

(71) Applicants: KUKA Deutschland GmbH, Augsburg (DE); KUKA Systems GmbH, Augsburg (DE)

(72) Inventors: Juergen Blume, Friedberg (DE); Ingo Kresse, Augsburg (DE); Pascal Caprano, Augsburg (DE); Marcus Hofmann, Seesen (DE); Fabian Jennrich, Muenchen (DE)

(73) Assignees: KUKA Deutschland GmbH, Augsburg (DE); KUKA Systems GmbH, Augsburg (DE)

(21) Appl. No.: 18/846,878

(22) PCT Filed: Mar. 13, 2023
(86) PCT No.: PCT/EP2023/056354

§ 371 Date: Sep. 13, 2024

(30) Foreign Application Priority Data
Mar. 15, 2022 (DE) 10 2022 202 562.8
Mar. 15, 2022 (DE) 10 2022 202 563.6
Mar. 15, 2022 (DE) 10 2022 202 564.4
Mar. 15, 2022 (DE) 10 2022 202 569.5
Mar. 15, 2022 (DE) 10 2022 202 571.7

(51) Int. Cl. B25J 9/16

(52) U.S. Cl. CPC B25J 9/1676; B25J 9/163; B25J 9/1697

(57) ABSTRACT

A method for checking a safety configuration of a robot includes determining or providing a computer-implemented, three-dimensional environment model; providing at least one protection region, working region and/or tool monitoring region of the robot of its distance between a computer-implemented model of the robot and the environment model for different sections of the path; and visualizing a virtual representation of the at least one protection region, working region and/or tool monitoring region or path using a visualization device in an augmented reality for checking the at least one protection region, working region and/or tool monitoring region; and moving away from and/or towards at least one pose and/or at least one section of a provided path.

### CROSS-REFERENCE TO RELATED APPLICATIONS

This application is a national phase application under 35 U.S.C. § 371 of International Patent Application No. PCT/EP2023/056354, filed Mar. 13, 2023 (pending), which claims the benefit of priority to German Patent Application Nos. DE 10 2022 202 562.8, DE 10 2022 202 563.6, DE 10 2022 202 564.4, DE 10 2022 202 569.5, and DE 10 2022 202 571.7, each filed Mar. 15, 2022; and is related to U.S. patent application Ser. No. ______ (Attorney Docket No. KUKAR-189), U.S. patent application Ser. No. ______ (Attorney Docket No. KUKAR-190), U.S. patent application Ser. No. ______ (Attorney Docket No. KUKAR-192), and U.S. patent application Ser. No. ______ (Attorney Docket No. KUKAR-193), each filed Sep. 13, 2024, the disclosures of which are incorporated by reference herein in their entirety.

### TECHNICAL FIELD

The present invention relates to a method and system for checking a safety configuration of a robot, and to a computer program or computer program product for carrying out the method.

### BACKGROUND

Robot paths relevant to safety configuration can be specified in particular with the help of a simulated environment and/or by teaching, in particular of path points. Furthermore, so-called protection regions and/or working regions can be defined.

In particular, for starting up, it should preferably be checked in advance whether a real robot could or would collide with its real environment when moving towards a (specified) path, which can differ from the simulated environment or the real environment as it was during teaching, or whether the (defined or predefined) protection regions and/or working regions meet the safety requirements and/or, in particular, whether the real robot does not penetrate into the protection regions.

### SUMMARY

The object of the present invention is to improve the operation of robots, in particular (by) checking a safety configuration.

This object is achieved by a method, a system, or a computer program or computer program product for carrying out a method as described herein.

According to an embodiment of the present disclosure, a method for checking a safety configuration of a robot comprises a step of determining or providing a computer-implemented, three-dimensional environment model.

Furthermore, in one embodiment, the method can comprise a step of providing at least one protection region, working region, and/or tool monitoring region of the robot. Furthermore, in one embodiment, the method can comprise a step of visualizing a virtual representation of the at least one protection region, working region, and/or tool monitoring region using a visualization device in an augmented reality for checking the at least one protection region, working region, and/or tool monitoring region. Furthermore, in one embodiment, the method can comprise a step of moving away from and/or towards at least one pose and/or at least one section of a provided path.

According to one embodiment, the method can in particular comprise verifying and/or documenting a safety configuration of a robot. In one embodiment, by means of the at least one protection region visualized via augmented reality, it can be (more) quickly checked whether the robot or the robot software stops a movement of the robot if the at least one protection region is violated, in particular if a working region is left.

In one embodiment, this allows an inspector to more reliably and/or quickly check the specified or provided path for the risk of possible collisions with the real environment and/or for leaving a working region or for being injured or entering a protection region, and/or in particular (re)check a specified and/or provided safety configuration, in particular its protection regions, working regions, and/or tool monitoring regions. In one embodiment, the safety configuration is checked, preferably by the or an inspector, with the aid of or on the basis of the visualized virtual representation of the at least one protection region, working region, and/or tool monitoring region, in particular by a movement away from or towards at least one section of a provided path, in particular the at least one specified path of the robot, and/or the at least one pose of the robot.

In one embodiment, moving away from or towards (at least) a provided path can be carried out (initially) in a mixed reality, in particular with a robot model.

Subsequently or alternatively, moving away from and/or towards (at least) one provided path can be carried out in an augmented reality with the real robot. In one embodiment, this allows a security configuration to be verified (more) quickly, in particular checked (for plausibility) and, in particular, documented.

In one embodiment, the method can advantageously be carried out in such a way that checking a safety configuration can be performed more quickly, in particular in such a way that a robot can be moved more quickly than without visualizing a virtual representation of the at least one protection region, working region, and/or tool monitoring region in order to approach or depart from a path and/or pose, in particular a specified or provided one, in order to check or document compliance with the at least one protection region. The speed of moving away from and/or towards can be at least twice as high as a speed when checking a safety configuration without visualization in an augmented reality, in particular at least twice as high as moving away from and/or towards a path and/or a pose as it is intended or provided for the path and/or pose (in an application).

In one embodiment, the robot has a robot arm with three or more, preferably at least six—in one embodiment, at least seven—joints—in a further development, rotary joints—which connect movable members of the robot to one another and are movable by drives, in particular motors, of the robot, and/or a mobile base, in particular movable with the aid of at least one drive, in particular motor, of the robot. For such robots, the invention is particularly advantageous, in particular due to the thereby enabled complex paths, poses, and, in particular, requirements for a safety configuration. In one embodiment, a robot-guided tool or workpiece forms a (distal) movable member of the robot in the sense of the present invention, or the model of the robot (also) comprises a model of a robot-guided tool or workpiece.

A safety configuration in the sense of the present disclosure is preferably to be understood as a specified and/or predefined configuration of protection regions, working regions, and/or tool monitoring regions, in particular in order to protect an environment and/or persons in the vicinity of the robot. In one embodiment, the protection regions, working regions, and/or tool monitoring regions can be created via software, in particular via 3-D simulation software and/or robot software, and/or transmitted to the robot, in particular a robot system and/or a controller of the robot. It is known that usually the protection regions, working regions, and/or tool monitoring regions are entered manually into the software or created in the software.

The safety configuration, in particular the at least one protection region, working region, and/or tool monitoring region, is specified in one embodiment by means of a program or by a (work) program and is—in particular, will be—specified in a further development with the aid of a simulated environment, in particular via a computer, and/or by learning or teaching.

In one embodiment, the three-dimensional environment model comprises, in particular, permanently or temporarily stored data that specify or describe one or more three-dimensional contours or geometries of a real environment of the robot, in particular a robot cell, production or warehouse hall, or the like.

In one embodiment, the model of the robot comprises, in particular, permanently or temporarily stored data that indicate or describe the three-dimensional contour(s) or geometry (geometries) of the (real) robot, in particular one or more of its movable limbs. As mentioned above, in one embodiment, a robot-guided tool or workpiece forms a (distal) movable member of the robot in the sense of the present disclosure, or the model of the robot (also) comprises a model of a robot-guided tool or workpiece.

In one embodiment, the method comprises the step of:
collecting data from a real environment of the robot using a detection device which, in one embodiment, is mobile and, in a further development, is in particular portable by a person;
wherein the environment model is determined based upon this collected data.

In one embodiment, this makes it possible to take into account the real environment of the robot during checking, and therefore to allow the risk of a collision with it to be very reliably checked. In a further development, it can be checked whether a safety configuration—moreover, in particular, the at least one protection region, working region, and/or tool monitoring region—meets the requirements for safety with regard to the determined environment model. In other words, in one embodiment, it can be checked or verified whether a safety configuration violates a protection region or a working region is left when moving towards and/or moving towards a provided path and/or a provided pose.

In one embodiment, the detection device is arranged on the visualization device—in a further development, integrated or detachably. In one embodiment, this makes it possible to determine the environment model in situ or shortly before visualization, and thereby makes it particularly up-to-date, and therefore makes the check particularly reliable and informative.

In one embodiment, the detection device is moved translationally and/or rotationally relative to the real environment to acquire the data. This means that, in one embodiment, a larger region of the environment, and/or the environment, can be detected more precisely, and thereby makes the check particularly reliable and informative.

In one embodiment, the detection device has one or more contact-free measuring distance meters, and, in a further development, one or more radar distance meters, one or more ultrasonic distance meters, and/or one or more lidar distance meters. This allows the environment model to be detected more precisely in one embodiment, and thereby makes the check particularly reliable and informative. Lidar distance meters are particularly advantageous because they are constructed compactly and measure precisely.

Additionally or alternatively, the detection device in one embodiment has one or more cameras—in a further development, a 3-D camera system—which in one embodiment has at least two or stereo cameras, a triangulation system in which at least one light source images a defined pattern onto the environment, and at least one camera records this pattern, preferably from a different angle, at least one TOF camera, at least one interferometry camera, at least one light field camera or the like, and/or an image evaluation. This allows the environment model to be detected more quickly in one embodiment, so that the check is carried out particularly quickly, and/or a larger environment is taken into account.

Alternatively, or particularly preferably in addition to the determination based upon detected data from the real environment, the environment model is determined, in one embodiment, based upon specified target data—in a further development, CAD data—of the environment. By taking such data into account, the environment model can, in one embodiment, be determined more quickly and/or precisely.

In one embodiment, the model of the robot is determined on the basis of specified target data, and in a further development on the basis of the specified path of the robot and/or on the basis of CAD data of the robot, and/or a measurement by the robot. By taking such data into account, the model of the robot can in one embodiment be determined (more) quickly and/or precisely. In one embodiment, the model of the robot for the various sections of a path has or indicates a pose, specified by the path, of the robot members relative to each other and/or to an environmentally fixed reference system. A pose or position in the sense of the present invention in one embodiment comprises a one-, two-, or three-dimensional position and/or a one-, two-, or three-dimensional orientation.

As explained above, in one embodiment, a robot-guided tool or workpiece forms a movable member of the robot in the sense of the present invention. Accordingly, in one embodiment, the model of the robot comprises a computer-implemented model of a robot-guided tool or workpiece as a movable member of the robot. In one embodiment, this makes it possible, advantageously, to check the risk of a robot-guided tool or workpiece colliding with the protection region, in particular leaving the working region or entering a protection region. Accordingly, in one embodiment, the model of the robot is determined on the basis of specified target data, and, in a further embodiment, CAD data, of the tool or workpiece, and/or a measurement of the tool or workpiece.

In one embodiment, the environment model has one or more geometry primitives in a specified relation, in particular spatial position, to a real environmental obstacle, in particular to a plurality of real environmental obstacles, each having at least one geometry primitive in a specified relation, in particular spatial position, to this real environmental obstacle. Additionally or alternatively, in one embodiment, the model of the robot has one or more geometry primitives in a specified relation, in particular spatial position, to a member of the robot, in particular to a plurality of members of the robot, preferably at least one end effector, each having at least one geometry primitive in a specified relation, in particular spatial position, to this robot member. This allows in one embodiment for the distance(s) to be determined (more) quickly. A geometry primitive in the sense of the present invention is, in one embodiment, a polyhedron, in particular a prism, in particular a cuboid, or a cylinder, cone, ellipsoid, in particular a sphere, or the like. In one embodiment, this allows the safety configuration, in particular the distance(s) to in particular a protection region, to be determined particularly quickly.

In one embodiment, the environment model is determined using at least one approximation of features detected using the detection device, in particular points, particularly preferably a point cloud detected using the detection device, in a further development using one or more grids and/or one or more approximation surfaces, in particular flat approximation surfaces and/or singly or multiply curved approximation surfaces, wherein such grids or approximation surfaces are determined in one embodiment by compensation, in particular interpolation or extrapolation, smoothing, and/or other fitting functions of points detected using the detection device; in particular, the environment model can feature this approximation. By means of such an approximation, the environment can be modeled in one embodiment in a particularly advantageous manner, in particular quickly and/or precisely.

In one embodiment, the environment model is determined on the basis of the robot, in particular with the aid of data from the robot detected by an, in particular the, detection device, and/or on the basis of the model of the robot. In a further development, the robot, which can also be detected when data from the real environment of the robot are detected using the detection device, is at least partially eliminated or hidden. In one embodiment, this allows the environment model to be improved.

In one embodiment, the environment model is determined based upon a selection of an environment region by an inspector. In a further development, an environment region selected by the inspector is not taken into account by the environment model; in a further development, it is not already detected using the detection device, and/or only an environmental region selected by the inspector is taken into account by the environment model; in a further development, only this environment region is detected using the detection device. In one embodiment, detection of the environment can be limited to a working region, and in particular to parts of a protection region. In one embodiment, this allows the environment model to be improved and/or determined (more) quickly.

In one embodiment, a distance between the model of the robot and the protection region is determined for one or more of the different sections of the path and/or a pose of the robot, in each case based upon a minimum distance between
an imaginary shell of a selected movable member of the robot—in one embodiment, of a robot-guided tool or workpiece,
or
an imaginary shell of several—in one embodiment, all—movable members of the robot—in one embodiment, accordingly including a robot-guided tool or workpiece,
and
a protection region which delimits at least part of the environment model from a working region, in particular a working region of the robot,
an imaginary shell of the entire environment of the robot described by the environment model, or
an imaginary shell of a selected part of this environment or shell,
which can in particular be the corresponding distance.

In one embodiment, in particular a distance between the robot model and/or an imaginary shell, as described above, can be obtained, in particular determined by the inspector, for a first assessment of a risk of injury or collision with the rules included in the safety configuration for the robot, in particular the protection region.

In one embodiment, an intersection, in particular an intersection volume, between the model of the robot and the protection region is determined for one or more of the different sections of the path and/or a pose of the robot, in each case based upon a minimum distance between
an imaginary shell of a selected movable member of the robot—in one embodiment, of a robot-guided tool or workpiece,
or
an imaginary shell of several—in one embodiment, all—movable members of the robot—in one embodiment, accordingly including a robot-guided tool or workpiece,
and
a protection region which delimits at least part of the environment model from a working region, in particular a working region of the robot,
an imaginary shell of the entire environment of the robot described by the environment model, in particular an imaginary shell spaced apart from this, or
an imaginary shell of a selected part of this environment or shell, in particular an imaginary shell spaced apart therefrom,
which can in particular be the corresponding intersection.

In one embodiment, an intersection is determined between the at least one protection region, working region, and/or tool monitoring region
and
an imaginary shell of the entire environment of the robot described by the environment model, in particular an imaginary shell spaced apart from this, or
an imaginary shell of a selected sub-region of this environment or shell, in particular an imaginary shell spaced apart there from, or
the environment model,
which can in particular be the corresponding intersection.

Such an imaginary shell is, in one embodiment, at least partially determined by the model of the robot or environment model—in one embodiment, one or more of the geometry primitives of the robot model, and/or one or more of the geometry primitives of the environment model, and/or the approximation of points detected using the detection device with the aid of which the environment model is determined or which the environment model has, and can in particular be formed at least partially by surfaces, corners, edges, nodes, coordinate lines, or the like of the geometry primitive or the approximation, in particular of the grid(s) or the approximation surface(s), and/or have a specified, in particular average, minimum, and/or maximum, distance from the robot (member) or a surface of the environment or the environment region and/or a specified, in particular average, minimum, and/or maximum, distance from the geometry primitive(s), grid(s), or approximation surface(s), or be correspondingly defined or specified. In particular, an imaginary shell can be continuous or also discrete. Accordingly, for example, the minimum distance and/or at least one intersection, in particular at least one intersection volume, between corners, edges, and/or surfaces of a geometry primitive of the robot model and a grid or an approximation surface of the environment model and/or the protection region, working region, and/or tool monitoring region can be used to determine a distance and/or an intersection, in particular an intersection volume, between the model of the robot and the environment model, and/or between the model of the robot and the protection region, working region, and/or tool monitoring region.

By determining the distance and/or an intersection, in particular an intersection volume, on the basis of a minimum distance and/or an intersection, in particular an intersection volume, of an imaginary shell of a plurality of—in one embodiment, all—movable members of the robot or of the at least one provided protection region and/or the entire environment of the robot described by the environment model, the check can in one embodiment be carried out (more) reliably; in particular, several different collision possibilities can also be taken into account, in particular a collision with the at least one protection region. In one embodiment, this can be carried out with the real robot before moving away from and/or towards at least one pose and/or at least one section of a provided path, and in particular indicates a faulty safety configuration. In one embodiment, it can thereby, advantageously, be ensured that a check of the safety configuration, in particular with the real robot, can be carried out quickly, in particular faster than without visualizing a virtual representation of the at least one protection region, working region, and/or tool monitoring region.

In one embodiment, the visualization device is a mobile, in particular portable (by a person, preferably with one hand) visualization device; in one embodiment, it has a handheld device, preferably a handheld, tablet, smartphone, laptop or the like, and/or glasses, in particular A(ugmented) R(eality) or V(irtual) R(eality) glasses. This allows checking to be carried out in situ or on-site, and thereby improved. In one embodiment, the visualization device is configured to control the robot (by hardware and/or software) or is (also) used for this purpose. This means in one embodiment that a startup can be carried out more quickly and/or safely.

In one embodiment, the (visualized) virtual representation comprises a depiction of one or more, in particular all, movable members of the robot—in one embodiment by means of or through geometry primitives of the model of the robot. In one embodiment, the depiction of the member(s) of the robot changes during the visualization according to the specified path; accordingly, the virtual representation can in particular comprise a virtual simulation of the robot or a representation of the movement of one or more of its limbs when moving away from the path.

In one embodiment, AR can also be understood as mixed reality, in particular for moving towards and/or away from at least one pose and/or at least one section of a provided path with the model of the robot.

In one embodiment, a warning can be issued when moving away from and/or towards the at least one pose and/or the at least one section of the path if a distance determined for this pose when moving towards and/or a distance determined for this section from a protection region and/or from an environment model lies in a specified warning region, in particular if at least one intersection, in particular an intersection volume, has been determined. In one embodiment, issuing a warning can relate only to moving towards and/or away from at least one pose and/or the at least one section of the path with the model of the robot. In this way, in one embodiment, it can advantageously be checked whether the safety configuration covers all, in particular new, obstacles in the environment, and the at least one protection region is defined, in particular provided, according to the complete environment (on-site), or the working region is defined, in particular provided, according to the complete environment (on-site).

A section of the path for which a warning is issued can consist of a (path) point or can be a (path) point for which the distance is determined.

In one embodiment, a section of the path for which a warning is issued extends on one or both sides beyond a (path) point or has several (path) points; it can be continuous or discrete, in particular a continuous or discrete sequence of points.

In one embodiment, in order to determine the distance for a section comprising several points, the distance of a selected one of these points, e.g., a start, end, or middle point of this section (as the distance of this section) is determined, and, in a further development, the section comprising several points is colored accordingly or as a function of the determined distance of this point. This allows the check to be carried out (more) quickly in one embodiment.

In one embodiment, to determine the distance for a section comprising several points, the distances of two or more discrete, in particular selected, points of this section, e.g., a start and an end point of this section, a start point, an end point, and a middle point of this section or the like, are determined, and the smallest of these distances is determined as the distance of this section. If this smallest distance is within a specified warning region, in one embodiment, a warning can be issued. In one embodiment, this allows the check to be carried out equally quickly and precisely.

In one embodiment, to determine the distance for a section comprising several points, in particular a continuous section, the minimum distance or the distance to the point closest to the protection region is determined as the distance of this section. This allows, in one embodiment, for the check to be carried out (more) precisely.

In a further development, a section, in particular a section consisting of one or more points, is colored accordingly or as a function of the determined distance. In one embodiment, this allows the precision of checking to be improved.

For example, a section is colored red to indicate a warning. Likewise, the coloring can also be multi-step and/or differently discretized, e.g., in {red, yellow, green} or the like, in particular with other colors and/or more finely discretized, or change continuously with the relevant, in particular smallest, distance—for example, from red for (excessively) small distances to green for (sufficiently) large distances or the like.

By visualizing the at least one protection region, working region, and/or tool monitoring region, in one embodiment, moving away from and/or towards can be carried out more quickly and/or reliably; in particular, an inspector can check or assess the at least one protection region, working region, and/or tool monitoring region (more) easily, intuitively, and/or quickly.

In one embodiment, issuing a warning comprises highlighting, preferably coloring and/or illuminating, the corresponding path or route section according to the distance determined for this purpose and/or the intersection determined for this purpose, in particular the intersection volume determined for this purpose, wherein different highlights, preferably colors or illuminations, can be assigned to the distance and/or the at least one intersection, in particular the at least one intersection volume, e.g., all distances in the warning region are given the color red, intersections are assigned the color red, in particular intersection volumes are assigned the color red, or all distances in the warning region are assigned the color red or a color that changes with the determined distance, in particular in the warning region, continuously, or several discrete steps, or the illumination changes with the distances.

Additionally or alternatively, issuing a warning can comprise highlighting, preferably coloring and/or illuminating, the representation of one or more, in particular all, movable members of the robot corresponding to the distance determined for the respective section and/or the intersection determined for the respective section, in particular the intersection volume determined for the respective section, wherein different distances can be assigned different highlights, preferably colors and/or illuminations, as described above. For example, the representation for or along sections with (too) small distances is colored red, and for or along sections with (sufficiently) large distances, in particular in the warning region, it is colored green; likewise, the color of the representation can change continuously or in several discrete steps with the determined distance, and/or the representation can be shown illuminated for distances in the warning region and non-illuminated outside the warning region, or its illumination can change with the distances.

By highlighting, in particular coloring and/or lighting (critical) distances and/or intersections, in particular intersection volumes, in one embodiment, an inspector can check or assess the path and/or the pose (more) quickly by highlighting, in particular coloring and/or illuminating, the representation of the robot member(s), in particular the robot model; (more) intuitively, by varying the visualization, the visualization can be made easier, and/or its recognizability can be improved.

In a further development, a first virtual representation is used to visualize the at least one protection region, working region, and/or tool monitoring region if the distance determined for these regions lies in a part of the warning region or at least one intersection has been determined or is present, and another first virtual representation is used for the visualization of the at least one protection region, working region, and/or tool monitoring region if the distance determined for these regions lies in another part of the warning region and/or no intersection has been determined. Additionally or alternatively, in a further development, a second virtual representation is used for the visualization of a section of the path if the distance determined for these regions lies outside the warning region.

The colors, lighting, styles, and classifications mentioned above are of course only examples, wherein a variety of other discretizations and/or warnings are possible.

In one embodiment, when visualizing the virtual representation of the at least one protection region, working region, and/or tool monitoring region, in particular a speed and/or at least one parameter, e.g., a speed for at least one section, in particular a point of the path selected in particular by an inspector, and/or at least one parameter, e.g., a speed for a section, in particular a point, of the path and/or pose that is just or currently being simulated during visualization, in particular simulated in real life, traveled to, or approached, is output.

In one embodiment, when visualizing the virtual representation of the at least one protection region, working region, and/or tool monitoring region, a checksum of the safety configuration from the robot controller, a date, a time, a serial number of the robot controller, and/or a serial number of the robot itself are displayed as a “watermark.”

In one embodiment, a video of at least moving away from and/or towards at least one pose and/or at least one section of a provided path, in particular of at least one method step included in the method, further in particular of all steps of the method, are recorded and/or generated, in particular comprising the safety configuration visualized by the visualization device, in particular with the at least one protection region, working region, and/or tool monitoring region.

In one embodiment, this makes it possible to dispense with paper documentation of checking the security configuration; in particular, the paper documentation can be replaced by video documentation; in particular, the checking of the security configuration can be carried out, in particular solely, by means of video documentation.

Additionally or alternatively, during visualization, in one embodiment, a value of the determined distance for at least one section of the path and/or pose from the at least one protection region, working region, and/or tool monitoring region, in particular a globally minimum distance and/or a distance for a section, in particular a point of the path and/or pose selected in particular by an inspector, and/or for a section of the path and/or pose that is just or currently being traveled or simulated during visualization, in particular a point that is approached in simulation, is output.

A parameter and/or a distance value is output numerically, acoustically, and/or symbolically. For example, a direction of travel can be output by an arrow, a TCP speed by a corresponding numerical indication, a distance value symbolically by a corresponding line, in particular a dimension line with ends symbolized, for example, by arrows, horizontal lines, or the like, acoustically, in particular by different pitches in relation to a reference tone, in particular a reference tone that corresponds to a zero value or specified value of the parameter, and/or numerically by a corresponding numerical indication.

By using one or more of the above-mentioned features, in one embodiment, an inspector can check or assess the security configuration (more) quickly and/or reliably.

In one embodiment, the robot is monitored for crossing a boundary between the working region and the protection region based upon detected joint positions (of the robot) and/or the (computer-implemented) model of the robot.

This means that in one embodiment monitoring can be particularly reliable and/or precise.

Depending upon the result of the check, the safety configuration, in particular the at least one protection region, working region, and/or tool monitoring region is in one embodiment modified—in a further development, by (input or specifications by) the inspector—in particular by means of an input device of augmented or virtual reality, further in particular via an input device of the visualization device, or also automatically. Then, a method described herein can be carried out again for or with the modified safety configuration, in particular for or with the modified protection region, working region, and/or tool monitoring region, in order to check this modified safety configuration in an analogous manner, wherein, in a further development, data of the real environment are again detected, and the environment model is again determined on the basis of this data, which can advantageously take changes in the real environment into account; in another further development, the previously used environment model is instead reused or (re)provided, which can advantageously reduce effort and time required.

The invention can be carried out with particular advantage during or for starting up the robot to check the safety configuration, since safety can be increased, and/or effort and/or time can be reduced in a particularly advantageous manner, but it is not limited thereto.

According to one embodiment of the present disclosure, a system, in particular in terms of hardware and/or software, in particular in terms of programming, is configured to perform a method described herein and/or comprises:
means for determining or providing a computer-implemented, three-dimensional environment model;
means for providing at least one protection region, working region, and/or tool monitoring region of the robot;
a visualization device for visualizing a virtual representation of the at least one protection region, working region, and/or tool monitoring region; and
means for moving away from and/or towards at least one pose and/or at least one section of a provided path.

In one embodiment, the system or its means comprises:
an, in particular mobile, in particular portable, detection device for detecting data of a real environment of the robot, and means for determining the environment model on the basis of these detected data, in particular with the aid of at least one approximation of points detected with the aid of the detection device; and/or
at least one contact-free measuring distance meter, in particular at least one lidar, radar, or ultrasonic distance meter, and/or at least one camera, in particular a 3-D camera system, and/or an image evaluation system; and/or
means for determining the environment model on the basis of specified target data, in particular CAD data, of the environment and/or on the basis of the robot, in particular using data of the robot detected, in particular by the detection device, and/or on the basis of the model of the robot and/or on the basis of a selection of an environment region by an inspector; and/or
means for determining the model of the robot on the basis of specified target data, in particular the specified path of the robot and/or CAD data of the robot, and/or a measurement of the robot;

In one embodiment, the system or its means can comprise: means for determining the distance between the model of the robot and the environment model for at least one of the different sections of the path on the basis of a minimum distance between an imaginary shell of a selected movable member of the robot or an imaginary shell of several, in particular all, movable members of the robot and an imaginary shell of the entire environment of the robot described by the environment model or a selected sub-region thereof.

In one embodiment, the system or its means can comprise: means for using a first virtual representation for visualizing the at least one protection region, working region, and/or tool monitoring region when a protection region will be or is violated, and a second virtual representation different therefrom when the protection region will not be or is not violated, in particular a different first virtual representation when a determined distance from at least a part of the robot and/or the robot model lies in a warning region.

In one embodiment, the system or its means can comprise: means for outputting at least one parameter, in particular a checksum of the safety configuration from the robot controller, a date, a time, a serial number of the robot controller, and/or a serial number of the robot itself as a “watermark,” further, in particular, a speed for at least one section of the path and/or for a section, in particular a point of the path moved away from or towards during visualization, and/or a value of a distance for a selected section of the path from the at least one protection region, working region, and/or tool monitoring region, and/or for a section, in particular a point of the path moved away from or towards during visualization, when visualizing the virtual representation of the path, in particular numerically, acoustically, and/or symbolically.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to output output signals to a data bus. A memory system may comprise one or more, in particular different, storage media, in particular optical, magnetic, solid-state, and/or other non-volatile media. The program can be of such a nature that it embodies or is capable of carrying out the methods described herein, so that the processing unit is able to carry out the steps of such methods and thus, in particular, can visualize the virtual representation of the path or issue the warning or all-clear signal. In an embodiment, a computer program product may comprise, in particular be, a, in particular computer-readable and/or non-volatile, storage medium for storing a program or instructions or with a program stored thereon or with instructions stored thereon. In one embodiment, execution of said program or said instructions by a system or controller, in particular a computer or an arrangement of a plurality of computers, causes the system or controller, in particular the computer(s), to carry out a method described herein or one or more steps thereof, or the program or instructions are configured to do so.

In one embodiment, one or more, in particular all, steps of the method are implemented completely or partially automatically, in particular by the system or its means.

In one embodiment, the system comprises the robot. In one embodiment, the safety configuration, in particular the protection region, is or will be specified in such a way that a collision therein between the robot and the environment occurs or is (more) likely, and/or the safety configuration, in particular the protection region, is or will be specified in such a way that no collision therein between the robot and the environment occurs or is (even) less likely.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for checking a safety configuration of a robot according to one embodiment of the present disclosure;

FIG. 2 depicts a modified system for checking a safety configuration of a robot according to one embodiment of the present disclosure; and

FIG. 3 schematically depicts a method for checking the safety configuration of the robot according to one embodiment of the present disclosure.

### DETAILED DESCRIPTION

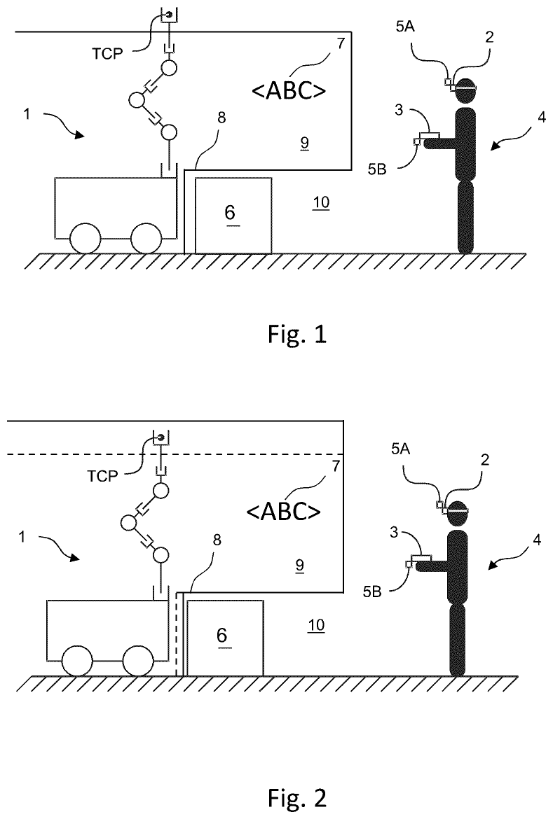

FIG. 1 depicts a system for checking a safety configuration of a robot 1 using a visualization device in the form of AR glasses 2 or a tablet 3 by an inspector 4.

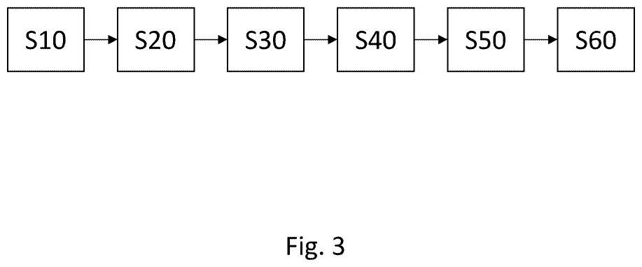

In a step S10 (cf. FIG. 3), a real environment 6 of the robot is detected using a detection device 5A or 5B arranged on the visualization device 2 or 3, preferably integrated or detachable, e.g., a 3-D camera system, lidar sensor, or the like, and, in a step S20, a computer-implemented environment model is determined using these data. In a variation (not shown), the environment model can additionally or alternatively be created on the basis of target data of the environment or can only be made available—for example, retrieved from a memory.

In a step S30, at least one protection region, working region, and/or tool monitoring region is provided, wherein the safety configuration, in particular the at least one protection region, working region, and/or tool monitoring region, has been specified, for example, with the aid of a simulated environment, by 3-D simulation software or by teaching.

For example, the robot model can have geometry primitives in the form of cuboids, cylinders, or the like, each of which is assigned to one of the movable members of the robot and whose pose or position changes accordingly according to a respective section or path point or when the robot simulates moving away from a path. The protection region and/or the environment model can, for example, have a grid or an approximation surface that approximates a point cloud detected in the environment model when detecting the real environment. The minimum distance between all these geometry primitives and the grid or the approximation surface of the environment model is then determined as the distance between the robot and the environment model. An intersection, in particular an intersection volume, is then determined, for example, between the robot, the robot model, and/or the environment model.

In a step S40, a virtual representation of the at least one protection region 10, working region 9, and/or tool monitoring region is visualized using the visualization device 2 or 3 in an augmented reality for checking the safety configuration—for example, when moving away from and/or towards a path of the TCP as a line, and/or the geometry primitives when simulating moving away from a path.

In this visualization, a warning is issued for a section of the path if the distance determined for this section lies within a specified warning region and/or at least one intersection, in particular an intersection volume, has been determined or exists—for example, in the manner described above by highlighting corresponding sections or the like.

Using this visualized virtual representation and the issued warnings, the inspector 4 can check in step S40 whether, for the safety configuration of the robot, there is a risk of a collision by robot 1 with the environment when moving away from a specified path or how great it is, and/or whether the robot violates or passes through a protection region when moving away from the specified path.

In this case, the inspector 4 can advantageously limit or concentrate on the sections for which a warning is issued and check these (more) precisely and, if necessary, modify the path, in particular in such sections, and/or the safety configuration, in particular the at least one protection region, working region, and/or tool monitoring region, in a step S50, whereupon the steps S30, S40, and, if necessary, S50 can be carried out again.

The checked safety configuration can be run (again) with the real robot in a step S60, in particular documented. At least one parameter 7 can be visualized (for this purpose), in particular a checksum of the safety configuration from the robot controller, a date, a time, a serial number of the robot controller, and/or a serial number of the robot itself, in particular as a “watermark.”

In FIG. 1, the robot 1 violates a protection region 10 or leaves a working region 9. The inspector 4 can determine this on the one hand via a simulation with a robot model, or check the safety configuration, wherein the robot model is virtually visualized in the visualization device when moving away from and/or towards a pose and/or at least part of a path, or on the other hand via moving away from and/or towards a pose and/or at least part of a path with the real robot, wherein a protection region, working region, and/or a tool monitoring region will be or is visualized in the visualization device, and in particular a robot model will be or is hidden or not visualized.

In FIG. 2, an example of a modified protection region 10 or modified working region 9 is shown—for example, in response to the collision or violation of the protection region in FIG. 1. The inspector 4 can modify a protection region and/or tool monitoring region, or a working region via an input device of the visualization device 2, 3.

Although exemplary embodiments have been explained in the preceding description, it is pointed out that a large number of modifications are possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
2 AR glasses
3 Tablet
4 Inspector
5A, 5B Detection device
6 Environment
7 Parameters in AR
8 Boundary of the regions displayed in AR
9 Working region

1-12. (canceled)

13. A method for checking a safety configuration of a robot, comprising:
obtaining a computer-implemented, three-dimensional environment model;
defining at least one protection region, working region, and/or tool monitoring region of the robot;
visually displaying in an augmented reality a virtual representation of the at least one protection region, working region, and/or tool monitoring region using a visualization device;
evaluating a movement of the robot relative to at least one of: (a) at least one pose, or (b) at least one section of a specified path, using the virtual representation; and
moving the robot away from and/or toward the at least one pose and/or the at least one section of the specified path based on the evaluation.

14. The method of claim 13, further comprising:
detecting data of a real environment of the robot using a detection device;
wherein obtaining the environment model comprises determining the model on the basis of the detected data.

15. The method of claim 14, wherein at least one of:
the detection device is one of a portable or mobile detection device;
the model is determined with the aid of at least one approximation of features detected with the detection device; or
the model is determined with the aid of at least one approximation of points detected with the detection device.

16. The method of claim 14, wherein at least one of:
the detection device is arranged on the visualization device;
the detection device is moved at least one of translationally or rotationally relative to the real environment to detect the data;
the detection device includes at least one contact-free measuring distance meter; or
the detection device includes at least one camera.

17. The method of claim 16, wherein at least one of:
the at least one contact-free measuring distance meter comprises at least one lidar, radar, or ultrasonic distance meter; or
the at least one camera comprises at least one of a 3-D camera system or an image evaluation system.

18. The method of claim 13, wherein at least one of:
the environment model is determined on the basis of specified target data;
the environment model includes at least one three-dimensional geometry primitive in a specified relation to a real environmental obstacle;
a model of the robot is determined on the basis of at least one of specified target data or a measurement of the robot;
the model of the robot includes at least one three-dimensional geometry primitive in a specified relation to a member of the robot; or
the model of the robot includes a computer-implemented model of a robot-guided tool or workpiece as a movable member of the robot.

19. The method of claim 18, wherein at least one of:
the specified target data for determining the environment model comprises CAD data of the environment; or
the specified target data for determining the robot model comprises at least one of: a) data of the specified path of the robot, or b) CAD data of the robot.

20. The method of claim 13, wherein obtaining the environment model comprises at least one of:
determining the environment model based on the robot;
determining the environment model based on a model of the robot; or
determining the environment model based on a selection of an environment region by an inspector.

21. The method of claim 20, wherein:
determining the environment model based on the robot comprises determining the environment model based on robot data; or
determining the environment model based on the robot comprises determining the environment model based on robot data detected using a detection device.

22. The method of claim 13, wherein at least one of:
the visualization device is at least one of mobile or portable;
the visualization device is configured as a handheld device;
the visualization device comprises at least one of a smartphone or glasses; or
the visualization device is configured to control the robot.

23. The method of claim 13, further comprising:
outputting at least one parameter as a virtual watermark during the visually displaying of the virtual representation.

24. The method of claim 23, wherein at least one of:
the at least one parameter is at least one of:
a checksum of the safety configuration from the robot controller,
a date,
a time,
a serial number of the robot controller,
a serial number of the robot,
a speed for the at least one section of a path and/or for a section, in particular a point, of the path that is moved away from or towards during visualization, or
a value of a distance for a selected section of the path from the at least one protection region, working region, and/or tool monitoring region and/or for a section, in particular a point, of the path that is simulated during visualization; or
the virtual watermark is output at least one of numerically, acoustically, or symbolically.

25. The method of claim 13, further comprising, when moving away from and/or toward the at least one pose and/or the at least one section of the path, at least one of:
issuing a warning is in response to a determination that a distance of at least a part of the robot from a defined protection region lies in a specified warning region; or
issuing a warning is in response to a determination of an intersection of at least a part of the robot with the protection region or an intersection volume.

26. The method of claim 13, further comprising:
modifying at least one of the at least one pose; the specified path; or at least one of the protection region, working region, or tool monitoring region, in response to the evaluation determining an intersection of at least a part of the robot with the protection region or an intersection volume.

27. The method of claim 25, further comprising evaluating a movement of the robot relative to a pose and/or a section of the specified path for which a warning is issued using the virtual representation.

28. The method of claim 26, further comprising:
checking a virtual representation of the modified at least one protection region, working region, and/or tool monitoring region in the augmented reality using the visualization device; and
issuing a warning signal for at least one of the modified pose or a section of the modified path in response to a determination that a distance of at least a part of the robot from the modified at least one protection region, working region, or tool monitoring region is in a warning region.

29. A system for checking a specified path of a robot, the system comprising:
means for obtaining a computer-implemented, three-dimensional environment model;
means for defining at least one protection region, working region, and/or tool monitoring region of the robot;
a visualization device configured for visually displaying in an augmented reality a virtual representation of the at least one protection region, working region, and/or tool monitoring region; and
means for moving the robot away from and/or toward at least one pose and/or at least one section of a specified path in response to an evaluation of the movement of the robot using the virtual representation.

30. A computer program product for checking a safety configuration of a robot, the computer program product comprising program code stored on a non-transitory, computer-readable medium, the program code, when executed on a computer, causing the computer to carry out the method of claim 13.
